(19) United States
(12) Patent Application Publication
(10) Pub. No.: US 2019/0019468 A1
(43) Pub. Date: Jan. 17, 2019

(54) ARRAY SUBSTRATES AND DISPLAY PANELS

(71) Applicant: Shenzhen China Star Optoelectronics Semiconductor Display Technology Co., Ltd., Shenzhen, Guangdong (CN)

(72) Inventor: Longqiang SHI, Shenzhen, Guangdong (CN)

(73) Assignee: Shenzhen China Star Optoelectronics Semiconductor Display Technology Co., Ltd., Shenzhen, Guangdong (CN)

(21) Appl. No.: 15/577,862

(22) PCT Filed: Aug. 18, 2017
(86) PCT No.: PCT/CN2017/097993

§ 371 Date: Nov. 29, 2017

(30) Foreign Application Priority Data
Jul. 17, 2017 (CN) 201710582439.3

(51) Int. Cl. G09G 3/36

(52) U.S. Cl. CPC G09G 3/3655; G09G 2320/0242; G09G 2320/0204

(57) ABSTRACT

The present disclosure relates to an array substrate and a display panel. The array substrate includes a plurality of scanning lines, and a plurality of data lines intersecting with the scanning lines to define a plurality of pixel areas. The array substrate further includes a control circuit connecting to the data lines. The control circuit is configured to maintain a voltage on the data lines to be the same with the voltage on a common electrode. The voltage of the pixel electrode within the pixel areas is the same with the voltages on the data lines so as to balance a voltage difference between the pixel electrode and the common electrode. In this way, the liquid crystal may not be twisted so as to avoid the white blur.

### BACKGROUND OF THE INVENTION

### 1. Field of the Invention

The present disclosure relates to liquid crystal display technology, and more particularly to an array substrate and a display panel.

### 2. Discussion of the Related Art

Liquid crystal devices (LCDs) are characterized by attributes, such as small size, low power consumption, low radiation, and thus have been the major product in the flat display field. With the development of liquid crystal display technology, attributes including high resolution, high contrast, narrow borders, and thinner have become the trend of liquid crystal display. With respect to Gate Driver On Array (GOA), the driving circuits performing horizontal scanning may be manufactured in a rim of the display area of the substrate by the original manufacturing process, such that the original external Integrated Circuit (IC) may be replaced so as to complete the horizontal scanning. This not only reduces the manufacturing process of the external IC and the product costs, but may contribute to the narrow border design.

In the long-term research and development, it is found that the common electrode and the pixel electrode are provided on both sides of the liquid crystal layer in the liquid crystal display. When the GOA-LCD is turned off, the discharge of the common electrode is slow, When the pixel electrode is discharged to OV, the common electrode is maintained at a voltage greater than 3V, so that the common electrode and pixel electrode pressure is greater than 3V. This may result in liquid crystal deflection, and the screen may include white blur.

### SUMMARY

The present disclosure relates to an array substrate and a display panel to resolve the white blue issue when the LCD is turned off.

In one aspect, an array substrate includes: a plurality of scanning lines; a plurality of data lines intersecting with the scanning lines to define a plurality of pixel areas; a control circuit connecting to the data lines, the control circuit being configured to maintain a voltage on the data lines to be the same with the voltage on a common electrode, and the voltage of the pixel electrode within the pixel areas being the same with the voltages on the data lines so as to balance a voltage difference between the pixel electrode and the common electrode.

In another aspect, a display panel includes: a first substrate, a second substrate, and a liquid crystal layer between the first substrate and the second substrate; wherein the first substrate is an array substrate includes: a plurality of scanning lines and data lines intersecting with each other so as to define a plurality of pixel areas; a control circuit connecting to the data lines for keeping the voltages on the data lines to be the same with the voltages of the common electrode when the display panel is turned off, and the voltage of the pixel electrode within the pixel areas being the same with the voltage on the data lines so as to balance a voltage difference between the pixel electrode and the common electrode.

In the present disclosure, the data lines connect to the control circuit. The voltage of the data lines is changed when the LCD is turned off, such that the voltage difference between the pixel electrode and the common electrode may be balanced. The liquid crystal are not twisted so as to reduce the white blur.

### BRIEF DESCRIPTION OF THE DRAWINGS

FIG. 1 is a schematic view of the array substrate in accordance with one embodiment of the present disclosure.

FIG. 2 is a schematic view of the array substrate in accordance with another embodiment of the present disclosure.

FIG. 3 is a schematic view showing the voltage variation of each points of the array substrate in accordance with one embodiment of the present disclosure.

FIG. 4 is a schematic view of the display panel in accordance with one embodiment of the present disclosure.

### DETAILED DESCRIPTION OF THE EMBODIMENTS

Embodiments of the invention will now be described more fully hereinafter with reference to the accompanying drawings, in which embodiments of the invention are shown.

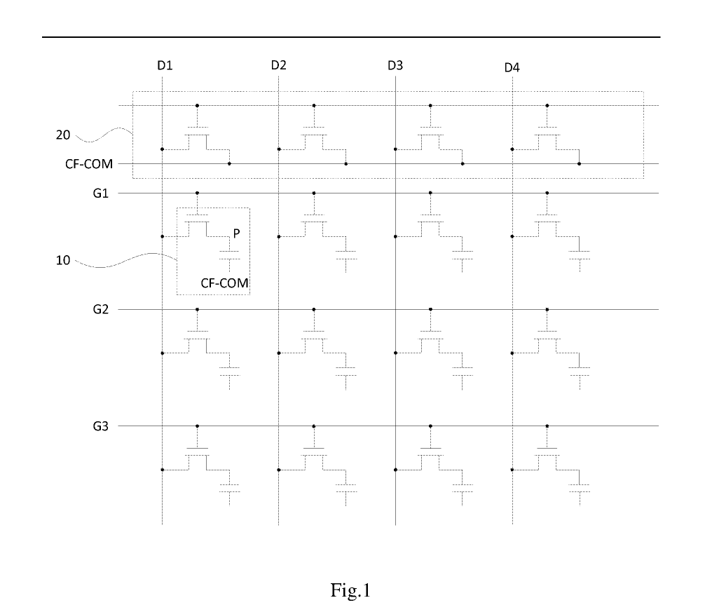

Referring to FIG. 1, the array substrate may include:

A plurality of scanning lines (Gn). In an example, the array substrate includes the scanning lines (G1-G3).

A plurality of data lines (Dn). In an example, the array substrate includes the data lines (D1-D4) intersecting with the scanning lines (Gn) to define a plurality of pixel areas 10.

A control circuit 20 connecting to a plurality of data lines (Dn). When the LCD is turned off, the voltage of the data lines (Dn) are the same with the voltage of the common electrode (CF-COM). The voltage of the pixel electrode (P) within the pixel area 10 is the same with the voltage on the data lines (Dn) such that a voltage difference between the pixel electrode (P) and the common electrode (CF-COM) may be balanced.

In an example, the control circuit 20 may include at least one thin film transistor (TFT) and other components. With such configuration, when the LCD is turned off, the voltage of the data lines (Dn) and the voltage of the common electrode (P) within the pixel areas 10 are balanced. As such, the voltage difference between the common electrode (P) within the pixel areas 10 and the common electrode (CF-COM) are balanced, and the liquid crystal are not twisted.

In an example, the array substrate may be adopted by displays, such as LCD.

In the present disclosure, the data lines connect to the control circuit. The voltage of the data lines is changed when the LCD is turned off, such that the voltage difference between the pixel electrode and the common electrode may be balanced. The liquid crystal are not twisted so as to reduce the white blur.

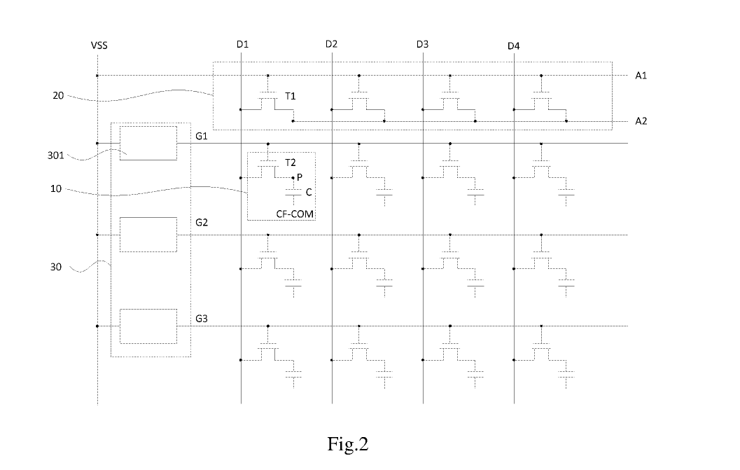

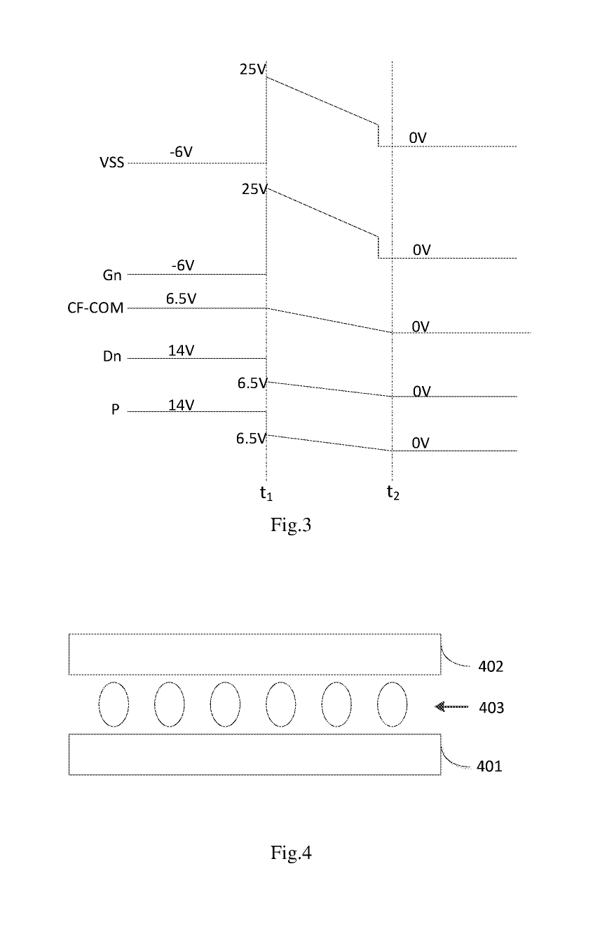

Referring to FIGS. 2 and 3, in one embodiment, the array substrate includes:

A plurality of scanning lines (Gn). In an example, the array substrate includes the scanning lines (G1-G3).

A plurality of data lines (Dn). In an example, the array substrate includes the data lines (D1-D4) intersecting with the scanning lines (Gn) to define a plurality of pixel areas 10.

A control circuit 20 connecting to a plurality of data lines (Dn). When the LCD is turned off, the voltage of the data lines (Dn) are the same with the voltage of the common electrode (CF-COM). The voltage of the pixel electrode (P) within the pixel area 10 is the same with the voltage on the data lines (Dn) such that a voltage difference between the pixel electrode (P) and the common electrode (CF-COM) may be balanced.

The control circuit 20 includes a first control line (A1), a second control line (A2), and a plurality of TFTs (T1), wherein the first control line (A1) connects to a direct-current low voltage (VSS), the second control line (A2) connects to the common electrode (CF-COM), a gate of the TFTs (T1) connects to the al connects to the first control line (A1), a source of the second transistor (T2) connects to the data line (Dn), and a drain of the TFTs (T1) connects to the second control line (A2).

The pixel areas 10 includes a second TFT (T2). A gate of the second TFT (T2) connects to the scanning line (Gn), a source of the second TFT (T2) connects to the data lines (Dn), and a drain of the second TFT (T2) connects to the common electrode (P). The pixel areas 10 further includes a liquid crystal capacitor (C) equivalent to the liquid crystal layer. A first end of the liquid crystal capacitor (C) connects to the common electrode (P), and a second end of the liquid crystal capacitor (C) connects to the common electrode (CF-COM). The liquid crystals are controlled by the voltages at two ends of the liquid crystal capacitor (C), that is, the voltage between the common electrode (P) and the common electrode (CF-COM).

The liquid crystal panel 30 includes a plurality of driving units 301. A first end of the driving unit 301 connects to the direct-current low voltage (VSS), and a second end of the driving unit 301 connects to a corresponding scanning line (Gn).

In an example, the liquid crystal panel 30 may be a GOA circuit.

In an example, the direct-current low voltage (VSS) may be a direct-current low voltage ranging from −14 V to −4 V.

In an example, the array substrate receives the turn-off signals at the moment (t1), the voltage on the first control line (A1) transits from −6 V to 25 V due to the inputted direct-current low voltage (VSS), such that the TFTs (T1) on the first control line (A1) are turned on. At this moment, the voltage on the data lines (Dn) transits from 14V to be the same with the voltage on the second control line (A2), that is, the voltage of the common electrode (CF-COM), i.e., 6.5V. At the same time, the voltage on the scanning lines (Gn) transits from −6V to 25V due to the inputted direct-current low voltage (VSS), such that the second TFTs (T2) on the scanning lines (Gn) are all turned on. At this moment, the voltage on the common electrode (P) transits from 14V to be the same with the voltage on the data lines (Dn), i.e., 6.5V. The voltages at two ends of the liquid crystal capacitor (C) are both 6.5V, and the voltage difference equals to zero. Afterward, the two ends of the liquid crystal capacitor (C) discharge at the same time. Until the moment (t2), the voltages at two ends of the liquid crystal capacitor (C) transits to be zero. As the voltages at two ends of the liquid crystal capacitor (C) are equal. Thus, the liquid crystal are not twisted, and the white blur may be avoided.

In the present disclosure, the data lines connect to the control circuit. The voltage of the data lines is changed when the LCD is turned off, such that the voltage difference between the pixel electrode and the common electrode may be balanced. The liquid crystal are not twisted so as to reduce the white blur.

Referring to FIG. 4, the display panel may include:

A first substrate 401, a second substrate 402, and a liquid crystal layer between the first substrate 401 and the second substrate 402, wherein the first substrate 401 is an array substrate includes: a plurality of scanning lines and data lines intersecting with each other so as to define a plurality of pixel areas; a control circuit connecting to the data lines for keeping the voltages on the data lines to be the same with the voltages of the common electrode when the LCD is turned off. In this way, the voltage difference between the pixel electrode and the common electrode may be balanced.

In one embodiment, the structure of the array substrate may be referenced in the above embodiments.

In the present disclosure, the data lines connect to the control circuit. The voltage of the data lines is changed when the LCD is turned off, such that the voltage difference between the pixel electrode and the common electrode may be balanced. The liquid crystal are not twisted so as to reduce the white blur.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An array substrate, comprising:
a plurality of scanning lines;
a plurality of data lines intersecting with the scanning lines to define a plurality of pixel areas;
a control circuit connecting to the data lines, the control circuit being configured to maintain a voltage on the data lines to be the same with the voltage on a common electrode, and the voltage of the pixel electrode within the pixel areas being the same with the voltages on the data lines so as to balance a voltage difference between the pixel electrode and the common electrode;
wherein the control circuit comprises:
a first control line connecting to a direct-current low voltage;
a second control line connecting to the common electrode;
a plurality of first thin film transistors (TFTs), a gate of the first TFT connects to the first control line, a source of the first TFT connects to the data line, and a drain of the first TFT connects to the second control line;
the pixel area comprises a second TFT, a gate of the second TFT connects to the scanning line, a source of the second TFT connects to the data line, and a drain of the second TFT connects to the pixel electrode.

2. The array substrate as claimed in claim 1, wherein the array substrate further comprises:
a driving circuit comprising a plurality of driving units, first ends of the driving units connect to the direct-current low voltage, and second ends of the driving unit connect to the corresponding scanning line.

3. An array substrate, comprising:
a plurality of scanning lines;
a plurality of data lines intersecting with the scanning lines to define a plurality of pixel areas;
a control circuit connecting to the data lines, the control circuit being configured to maintain a voltage on the data lines to be the same with the voltage on a common electrode, and the voltage of the pixel electrode within the pixel areas being the same with the voltages on the data lines so as to balance a voltage difference between the pixel electrode and the common electrode.

4. The array substrate as claimed in claim 3, wherein the control circuit further comprises:
a first control line connecting to a direct-current low voltage;
a second control line connecting to the common electrode;
a plurality of first thin film transistors (TFTs), a gate of the first TFT connects to the first control line, a source of the first TFT connects to the data line, and a drain of the first TFT connects to the second control line.

5. The array substrate as claimed in claim 4, wherein the pixel area comprises a second TFT, a gate of the second TFT connects to the scanning line, a source of the second TFT connects to the data line, and a drain of the second TFT connects to the pixel electrode.

6. The array substrate as claimed in claim 4, wherein the array substrate further comprises:
a driving circuit comprising a plurality of driving units, first ends of the driving units connect to the direct-current low voltage, and second ends of the driving unit connect to the corresponding scanning line.

7. A display panel, comprising:
a first substrate, a second substrate, and a liquid crystal layer between the first substrate and the second substrate;
wherein the first substrate is an array substrate comprising:
a plurality of scanning lines and data lines intersecting with each other so as to define a plurality of pixel areas;
a control circuit connecting to the data lines for keeping the voltages on the data lines to be the same with the voltages of the common electrode when the display panel is turned off, and the voltage of the pixel electrode within the pixel areas being the same with the voltage on the data lines so as to balance a voltage difference between the pixel electrode and the common electrode.

8. The display panel as claimed in claim 7, wherein the control circuit comprises:
a first control line connecting to a direct-current low voltage;
a second control line connecting to the common electrode;
a plurality of first thin film transistors (TFTs), a gate of the first TFT connects to the first control line, a source of the first TFT connects to the data line, and a drain of the first TFT connects to the second control line.

9. The display panel as claimed in claim 8, wherein the pixel area comprises a second TFT, a gate of the second TFT connects to the scanning line, a source of the second TFT connects to the data line, and a drain of the second TFT connects to the pixel electrode.

10. The display panel as claimed in claim 8, wherein the array substrate further comprises:
a driving circuit comprising a plurality of driving units, first ends of the driving units connect to the direct-current low voltage, and second ends of the driving unit connect to the corresponding scanning line.

11. The display panel as claimed in claim 10, wherein the diving circuit is a gate driver on array (GOA) circuit.

12. The display panel as claimed in claim 10, wherein the direct-current low voltage is a direct-current low voltage ranging from −14 V to −4 V.

13. The display panel as claimed in claim 10, wherein the voltage of the common electrode is 6.5V when the display panel is turned off.
